(19) United States
(12) Patent Application Publication
(10) Pub. No.: US 2008/0233010 A1
(43) Pub. Date: Sep. 25, 2008

(54) Testing Hydrogen Flux Through Solid and Liquid Barrier Materials

(75) Inventors: James G. Blencoe, Harriman, TN (US); Michael Naney, Knoxville, TN (US)

Correspondence Address: BAKER BOTTS, LLP, 910 LOUISIANA, HOUSTON, TX, 77002-4995, US

(73) Assignee: HYDROGEN DISCOVERIES, INC., HARRIMAN, TN (US)

(21) Appl. No.: 12/050,412

(22) Filed: Mar. 18, 2008

Related U.S. Application Data
(60) Provisional application No. 60/918,767, filed on Mar. 19, 2007.
(60) Provisional application No. 60/910,684, filed on Apr. 9, 2007.

(51) Int. Cl. B01J 19/00; G01N 15/08; G01N 7/00; G01N 25/00

(52) U.S. Cl. 422/82.12; 73/38; 73/31.04; 73/25.01

(57) ABSTRACT

Apparatus and methods for testing the hydrogen-gas compatibilities, hydrogen-gas embrittlement susceptibilities, hydrogen-gas containment performances, and/or the hydrogen-gas pressure-cycling durabilities, of hollow enclosures (“test specimens”), with single-layer, double-layer, or multi-layer walls, composed of various barrier materials, are disclosed. Barrier materials include but are not limited to: carbon steel, stainless steel, copper, aluminum, a polymeric material (e.g., high-density polyethylene), and a liquid material (e.g., water, or an aqueous solution). The test gas is either high-purity hydrogen or a hydrogen-bearing gas mixture (e.g., hydrogen gas mixed with methane/natural gas and/or biomethane). A key piece of the testing equipment is an enclosure that surrounds the test specimen. Fabricated from high-strength, porous solid material (e.g., porous stainless steel), the enclosure (i) captures the hydrogen gas that diffuses through the wall(s) of the test specimen, and (ii) channels the flow of that gas toward a volume-calibrated reservoir.

### RELATED PATENT APPLICATIONS

This application claims priority to commonly owned:
U.S. Provisional Patent Application Ser. No. 60/918,767; filed Mar. 19, 2007; entitled “New, Composite Polymeric/Metallic Materials and Designs for Hydrogen Pipelines,” by James G. Blencoe, Simon Marshall and Michael Naney;
U.S. Provisional Patent Application Ser. No. 60/910,684; filed Apr. 9, 2007; entitled “New, Composite Polymeric/Metallic Materials and Designs for Hydrogen Pipelines,” by James G. Blencoe, Simon Marshall and Michael Naney; and
U.S. patent application Ser. No. 11/852,364; filed Sep. 10, 2007; entitled “Mitigating Hydrogen Flux Through Solid and Liquid Barrier Materials,” by James G. Blencoe and Simon Marshall;
   all of which are hereby incorporated by reference herein for all purposes.

### TECHNICAL FIELD

The present disclosure relates generally to apparatus and methods for testing structures for transferring and storing hydrogen gas, and more particularly, to testing of hollow structures, with single-layer, double-layer, or multi-layer walls composed of one or more solid and/or liquid barrier (e.g., hydrogen containment) materials.

### BACKGROUND

Renewable energy resources in the U.S. could satisfy most of the nation's future energy needs. However, distributed sources of domestic renewable energy—particularly those east of the Mississippi River—cannot meet the concentrated energy demands of large cities and heavy industry. The richest centralized renewable energy resources in the U.S.—wind energy in the Great Plains States, and solar energy in the American Southwest—are largely stranded; i.e., located far from population centers, with no means for energy transmission or storage. Long electric transmission lines could be built to tap these resources, but they are capital intensive, difficult to site and permit, and special financing may be required to recover transmission costs, and to earn a profit. In addition, if the transmitted electricity is produced entirely or mainly from wind or solar energy, overall system performance will be burdened by a low capacity factor (intermittency), and by the inability to store part of the energy to “smooth” or “firm” the delivery of power. For these reasons, converting the produced electricity to hydrogen, and transmitting the hydrogen through a network of pipelines, is a potentially viable alternative strategy for delivering the energy to distant markets. Building new underground pipelines has historically been easier and faster than constructing regional electric infrastructure. Moreover, large-scale electric-transmission and hydrogen-pipeline systems are comparable in capital, operating, and maintenance costs.

Thus, it has been suggested that large-scale, on-site, electrolytic or thermochemical production of hydrogen, bulk storage of the produced hydrogen gas, and long-distance pipeline hydrogen transmission, can provide “seasonally firmed” renewable energy to rural, suburban, and/or city-gate markets. To minimize greenhouse gas emissions, and to lower the costs of gas compression, the hydrogen could be formed from water (pumped from local aquifers, or delivered to each site by pipeline) using electrolyzers that create gaseous hydrogen at pressures as high as 1,500 pounds per square inch (psi). The resulting pressurized hydrogen gas is either directly injected into one or more pipes connected to a pipeline transmission system, or compressed to 2,000-2,500 psi for temporary storage.

Challenges for mass production of hydrogen gas in remote locations, and transmitting the hydrogen to distant points of end-use, are daunting. One of the main difficulties—long recognized and extensively studied, but still largely unresolved—is safe, efficient, and cost-effective pipeline delivery of gaseous hydrogen at pressures greater than or equal to 500 psi. Compressed to such levels, hydrogen is difficult to contain in two respects. First, due to the tiny size of its molecules, hydrogen will pass through the narrowest of passageways, which means that leakage is very difficult to prevent. Second, hydrogen readily dissolves in, and diffuses through, many of the solid materials that are commonly used to contain gases.

Most of the hydrogen produced today for commercial use is transferred short distances through relatively narrow-diameter pipes at nearly constant pressures of just a few hundred psi. For this purpose, carbon steel has been the principal material of choice for pipeline construction; however, cast iron, copper, various plastics—e.g., polyvinyl chloride (PVC) and high-density polyethylene (HDPE)—have also been used, particularly to transfer the gas over short distances.

A major concern for future, high-capacity hydrogen pipelines is long-term durability at internal gas pressures greater than or equal to 500 psi. It is well known that, at these pressures, carbon steels are susceptible to hydrogen embrittlement and cracking, and while the effects of high-pressure hydrogen on plastics are not well known, significant long-term negative impacts on these materials are also a real possibility. Hydrogen embrittlement of metals is generally manifested by surface cracking, crack propagation, decreases in tensile strength, loss of pipeline ductility, and reduced burst-pressure rating. This degradation can lead to premature failure of one or more segments of a pipeline, resulting in leakage of gas—or in extreme circumstances, bursting of a pipe. In view of these risks, it is not surprising that qualification of pipeline materials for hydrogen service at gas pressures greater than or equal to 500 psi is currently an area of active research and development.

It has been suggested recently that many of the pipeline cost, weight, welding and joining, repair, and safety issues associated with carbon steel can be resolved by switching to fiber-reinforced polymer (FRP) materials. The issues and challenges for adapting existing FRP pipeline technology to hydrogen service at pressures above about 500 psi are: evaluating polymeric materials for hydrogen compatibility and prolonged pressure-cycling; identifying methods for profitable manufacture of pipes with inside diameters greater than four inches; weighing the options for on-site pipeline fabrication, joining, and repair; determining the availability of sensor technologies for measuring gas temperature, pressure, and flow rate in real time; and writing the necessary codes and standards to meet the requirements of local, state, and federal regulatory agencies. In this regard, it is noteworthy that the use of spoolable FRP pipe—or better yet, FRP pipe continuously fabricated in the field—would greatly simplify installation of long-distance hydrogen pipelines, thereby lowering overall costs of pipeline construction. FRP pipes can withstand large strains, which allows them to be “bent” easily and emplaced as a continuous, seamless monolith. Finally, because FRP pipes can be manufactured with sensors embedded in their walls, it is likely that long-distance, large-diameter FRP pipelines built for hydrogen transmission could be operated as “smart structures.” This would enable lifetime performance-monitoring of the pipeline, which could result in substantial safety enhancements and long-term cost savings.

### SUMMARY

Therefore, there is a need for testing and qualification of pipe, pipeline and storage structures for hydrogen service at elevated gas pressures. According to teachings of this disclosure, the hydrogen-service efficacies of hollow structures of all wall designs, and wall thicknesses may be tested for both kinetically limited and “equilibrium” (steady-state) hydrogen diffusion therethrough.

More specifically, the testing technologies disclosed herein relate to diffusive hydrogen flux across the inner and outer surfaces (walls) of containers, e.g., pipes, or layers within those containers (“interlayers”), formed from one or more solid or liquid “barrier” materials. Containers for hydrogen gas constructed from solid materials often fail to prevent, or adequately control, release of enclosed hydrogen gas. In addition, permeation of hydrogen into a solid material can damage its microstructure and reduce its mechanical strength. The testing technologies described hereinbelow may be used for testing of containers, e.g., pipeline transmission/distribution and storage containers, comprising one or more layers of polymeric, metallic (pure metal and/or metal alloy), metal oxide, and/or liquid material(s), that may be used to either: (i) create one or more supplementary, or enhanced, barriers to diffusion of hydrogen gas; or (ii) capture hydrogen gas before it escapes to the surrounding environment.

Test results for various hydrogen transfer, containment, and recovery practices may be applied to the construction of enclosures and passageways of many different geometrical forms, e.g., planar, spherical, cylindrical, etc. However, testing of tubes of all types, and especially large-diameter (greater than or equal to 4″ inside diameter) pipes, are of particular interest, as they may be used to transmit, distribute and/or store large masses of gaseous hydrogen. These pipes, and some of their applications, are more fully described in commonly owned co-pending U.S. patent application Ser. No. 11/852,364; filed Sep. 10, 2007; entitled “Mitigating Hydrogen Flux Through Solid and Liquid Barrier Materials,” by James G. Blencoe and Simon Marshall; and which is hereby incorporated by reference herein for all purposes. The applications include, but are not limited to: (i) use of one or more layers of homogeneous or laminated polymeric material, and (optionally) solid metal(s), e.g., copper (Cu), aluminum (Al), or stainless steel, each metal with or without oxidized inner/outer surfaces (see FIGS. 1-3 of U.S. patent application Ser. No. 11/852,364) and/or liquid(s), to create multiple equilibrium and kinetic barriers to hydrogen diffusion; (ii) in special circumstances, physical separation of gaseous hydrogen from one or more static or flowing liquid interlayers; and (iii) when necessary, capture and recovery of escaping gaseous hydrogen at the points in a pipeline system where connections are made (see FIGS. 4-6 of U.S. patent application Ser. No. 11/852,364).

Testing of a hollow, single-layer structure, constructed from a metal or metal alloy, is contemplated herein. This structure may be used for transferring and/or storing hydrogen gas.

Testing of a hollow structure that is enclosed by (overlain, lined or coated with), or constructed from, layered polymer/metal/metal oxide material is contemplated herein. This structure may be used for transferring and/or storing hydrogen gas. Often, two or more layers of one or more of these three materials will be pressed together tightly to form one or more thicker, composite layers. This layering/interlayering of materials impedes diffusive hydrogen flux in three ways. First, it automatically creates “contact resistance” to hydrogen flux, a phenomenon whereby diffusion of gaseous hydrogen is deterred kinetically by abrupt changes in microstructure at the boundaries of the individual layers in the multi-layer structure. Second, permeation of gaseous hydrogen through the composite structure slows when the gas reaches the metal layer(s)/interlayer(s), because the equilibrium solubility of hydrogen in, and the steady-state rate of hydrogen diffusion through, the metallic material will be, respectively, much lower, and much slower, than in the non-metallic material. Third, when gaseous hydrogen moves through a layer of metallic material sandwiched between two layers of non-metallic material, the structural state of the gas is forced to switch from diatomic (in the inner layer of non-metallic material), to monatomic (in the metallic material), back to diatomic (in the outer layer of non-metallic material)—an alternation that is kinetically constrained by itself, but in addition, is further restrained physicochemically by the sharp discontinuities in solid-state microstructure that occur at the boundaries between the metallic and non-metallic layers.

Testing of a hollow structure for transferring and/or storing hydrogen gas is contemplated herein. This structure may be a three-layer, composite configuration consisting of an inner layer of polymeric material (e.g., high-density polyethylene, HDPE), an interlayer of metal (possibly with its inner and/or outer surfaces oxidized to enhance hydrogen-containment performance), and an outer layer of polymeric material (e.g., HDPE) (FIGS. 2 and 3 of U.S. patent application Ser. No. 11/852,364).

Testing of a hollow structure for transferring and/or storing hydrogen gas is contemplated herein. This structure may include one or more gas-tight covers placed over one or more parts of the structure (FIGS. 4-6 of U.S. patent application Ser. No. 11/852,364), or a single gas-tight cover may enclose the entire structure. Hydrogen gas exiting the structure is captured in the gas-tight cover(s) before it can escape to the surrounding environment. The gaseous hydrogen that accumulates in the interior of a cover is removed through one or more ports in the cover. Employing this strategy for hydrogen “recovery,” escape of gaseous hydrogen from containers is managed adequately rather then prevented completely.

Testing of a hollow structure for transferring and/or storing hydrogen gas is contemplated herein. This structure may have one or more walls that contain one or more interlayers of a (largely) stagnant or flowing liquid, which either: (i) affords the opportunity to use a “material of construction” that is much cheaper and much more flexible than one or more layers of polymer/metal/metal oxide; (ii) diverts the solid/liquid-state diffusion of hydrogen, or its buoyant ascent as a separate gas phase, toward one or more predetermined “points of egress”; or (iii) in the case of pipeline transfer of hydrogen gas from sites of electrolytic or thermochemical generation to remote destinations where it is used as a fuel, enables reverse flow of either high-purity water or an aqueous solution (see FIG. 7 of U.S. patent application Ser. No. 11/852,364).

Testing of one or more pipes with one or more polymer/metal ± metal oxide layers or interlayers is contemplated herein. These one or more pipes may be used primarily for storage of hydrogen gas. When the goal is to store large masses of gaseous hydrogen for stationary (“off board”) applications, tightly packed sets of these pipes may be placed in hydrogen “warehouses” or “silos” that provide seasonally firmed supplies of the gas to rural, suburban, and/or city-gate markets.

It is contemplated and within the scope of this disclosure that the various embodiments claimed herein may be utilized for testing and qualification of materials of construction for tubular, pipe, and pipeline transfer and/or storage of high-purity hydrogen and/or hydrogen-bearing gas, e.g., hydrogen gas mixed with methane/natural gas and/or biomethane.

According to a specific example embodiment of this disclosure, an apparatus for testing hydrogen flux through barrier materials comprises: a source of compressed hydrogen gas; a barrier material specimen test fixture, wherein the barrier material specimen test fixture is adapted for coupling hydrogen gas to a barrier material specimen under test, wherein the barrier material specimen forms an enclosed cavity that is pressurized from the source of compressed hydrogen gas; at least one first pressure measurement device coupled to the barrier material specimen test fixture, wherein the at least one pressure measurement device measures the hydrogen gas pressure in the enclosed cavity of the barrier material specimen; a temperature-controlled fluid in which the barrier material specimen test fixture and the barrier material specimen are immersed therein; at least one temperature measurement device, wherein the at least one temperature measurement device measures the temperature-controlled fluid; a volume-calibrated hydrogen-gas reservoir for collecting and temporarily storing hydrogen gas that permeates through the enclosed cavity formed by the barrier material specimen; at least one second pressure measurement device coupled to the volume-calibrated hydrogen-gas reservoir, wherein the at least one second pressure measurement device measures the hydrogen-gas pressure therein; and at least one fluid pump for raising and lowering the hydrogen gas pressure inside the enclosed cavity of the barrier material specimen.

According to another specific example embodiment of this disclosure, a method for testing hydrogen flux through barrier materials comprises the steps of: providing a source of compressed hydrogen gas; providing a barrier material specimen test fixture; providing a barrier material specimen for testing at least one hydrogen gas parameter thereof, wherein the barrier material specimen forms an enclosed cavity that is pressurized from the source of compressed hydrogen gas; providing a temperature-controlled fluid in which the barrier material specimen test fixture and the barrier material specimen are immersed therein; providing a volume-calibrated hydrogen-gas reservoir for collecting and temporarily storing hydrogen gas that permeates through the enclosed cavity formed by the barrier material specimen; measuring the hydrogen gas pressure in the enclosed cavity of the barrier material specimen; measuring the temperature of the temperature-controlled fluid; measuring the hydrogen gas pressure in the volume-calibrated hydrogen-gas reservoir; and raising and lowering the hydrogen gas pressure inside the enclosed cavity of the barrier material specimen.

### BRIEF DESCRIPTION OF THE DRAWINGS

A more complete understanding of the present disclosure thereof may be acquired by referring to the following description taken in conjunction with the accompanying drawings wherein:

FIG. 1 illustrates a schematic cross-sectional view of a tube/pipe test fixture designed and built according to specific example embodiments of this disclosure;

FIG. 2 illustrates a schematic cross-sectional view of the tube/pipe test fixture shown in FIG. 1;

FIG. 3 illustrates a photograph of a stainless-steel water tank/bath with an aluminum shell, as used in accordance with the teachings of this disclosure;

FIG. 4 illustrates a photograph of two immersion heater/circulators, as used in accordance with the teachings of this disclosure;

FIG. 5 illustrates a schematic diagram of a tube/pipe testing system that contains the tube/pipe test fixture illustrated in FIG. 1;

FIG. 6 illustrates a photograph of a pressure-temperature-time data recorder with a screen display that may be used in accordance with the teachings of this disclosure;

FIG. 7 illustrates a schematic diagram of an apparatus that may be used to cycle the internal gas pressures of tubes and pipes as they are being tested, according to the teachings of this disclosure;

FIG. 8 illustrates a hydrogen-gas reservoir with an internal bellows, distilled water being cyclically injected into and extracted therefrom; and

FIG. 9 illustrates a hydrogen-gas reservoir, distilled water being cyclically injected into and extracted therefrom.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of example embodiments are schematically illustrated. Like elements in the drawings will be represented by like numbers, and similar elements will be represented by like numbers with a different lower case letter suffix.

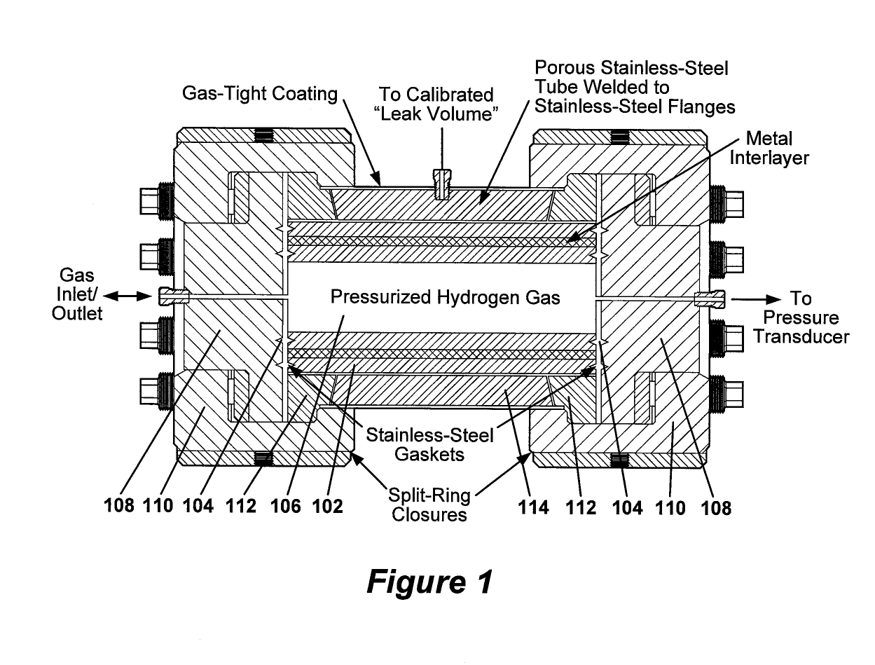

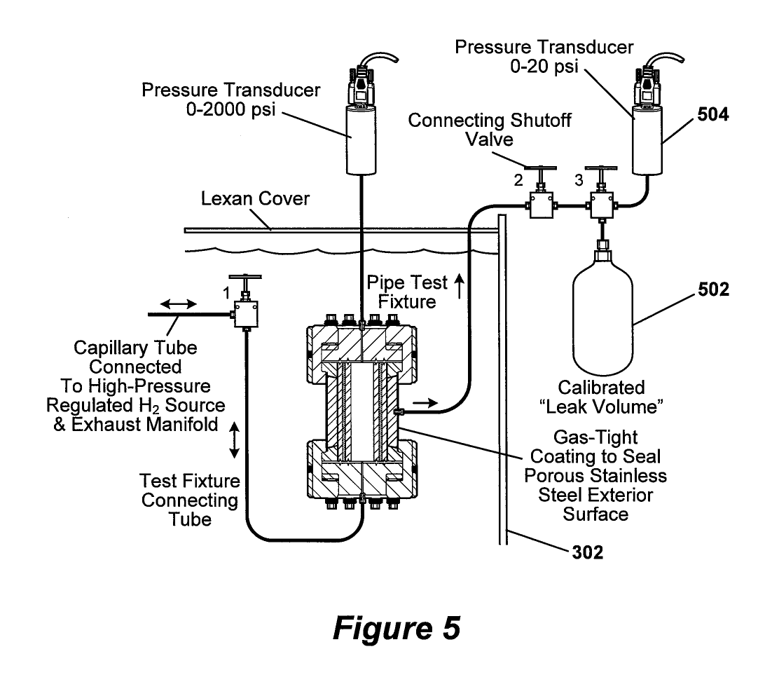

Referring to FIG. 1, depicted is a schematic cross-sectional view of a tube/pipe test fixture designed and built according to specific example embodiments of this disclosure. This novel device seals the open ends and outer wall of a single-layer, double-layer, or multi-layer tube or pipe 102 (see FIG. 1). In FIG. 1, the wall of the tube/pipe 102 has three layers composed of two barrier materials: an inner layer composed of high-density polyethylene (HDPE), an outer layer composed of HDPE, and a thin interlayer of copper sandwiched between the two layers of HDPE. Sealing of the two open ends of tube/pipe 102 is accomplished using two high-pressure metal gaskets 104 that force pressurized hydrogen gas 106 to diffuse through the wall of tube/pipe 102. The two end plugs 108, and the two closures 110, both of which support the two gaskets 104, use a high-pressure, split-ring design. The external support structure along the outer wall of tube/pipe 102 may be formed by welding stainless-steel flanges 112 to the ends of a length of porous stainless-steel tubing 114, the external surface of which is sealed to capture migrating hydrogen gas, forcing it to flow through capillary tubing connected to a calibrated “leak volume” (see FIG. 5).

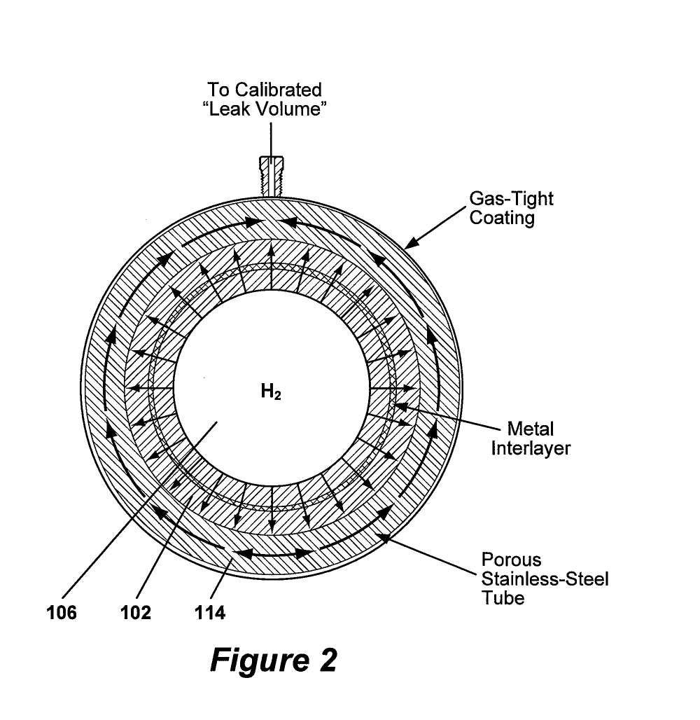

Referring to FIG. 2, depicted is a schematic cross-sectional view of the tube/pipe test fixture shown in FIG. 1. The view in FIG. 2 is a depiction of a cross-section perpendicular to the view shown in FIG. 1. FIG. 2 shows the dominant directions of hydrogen diffusion and flow in the tube/pipe test fixture when an experiment is underway. Referring to FIG. 2, some of the pressurized hydrogen gas 106 (i) diffuses through the multi-layer wall of tube/pipe 102, and subsequently (ii) enters the porous stainless-steel tube 114. The external surface of porous stainless-steel tube 114 is sealed to trap the migrating hydrogen gas, forcing it to flow toward and through the capillary tubing shown at the top of the figure, which is connected to a calibrated “leak volume” (see FIG. 5). Significantly, in addition to capturing the hydrogen gas that diffuses through the multi-layer wall of tube/pipe 102, and causing the resulting “released” hydrogen to flow toward a calibrated leak volume, the porous stainless-steel tube 114 also provides circumferential structural support for tube/pipe 102. This is important for the following two reasons. (1) Strong circumferential structural support for tube/pipe 102 eliminates the need to have a structurally strong outer layer on that tube/pipe. Therefore, in the case of multi-layer HDPE/metal/HDPE tubes and pipes, for example, there will be no need to have an outer layer (“wrap”) of fiber-reinforced polymer (FRP) to allow hydrogen gas 106 to be compressed to pressures as high as approximately 2000 psi inside tube/pipe 102. (2) Because the porous stainless-steel tube 114 provides all the circumferential support required to safely compress hydrogen gas 106 to pressures as high as 2000 psi, the wall thickness of tube/pipe 102 can be much thinner than it would otherwise have to be to safely contain hydrogen gas 106 compressed to pressures as high as 2000 psi. The thinner the wall of tube/pipe 102, the less time it will take to achieve steady-state hydrogen diffusion through the wall. Therefore, experiments performed with the testing apparatus, according to the teachings of this disclosure, can be of shorter duration than similar experiments performed using other types of equipment. This is of considerable practical importance in meeting deadlines set for testing the hydrogen-gas compatibilities, hydrogen-gas embrittlement susceptibilities, hydrogen-gas containment performances, and/or the hydrogen-gas pressure-cycling durabilities, of many kinds of tubes and pipes, including those made entirely from metal, e.g., carbon steel, stainless steel, etc.

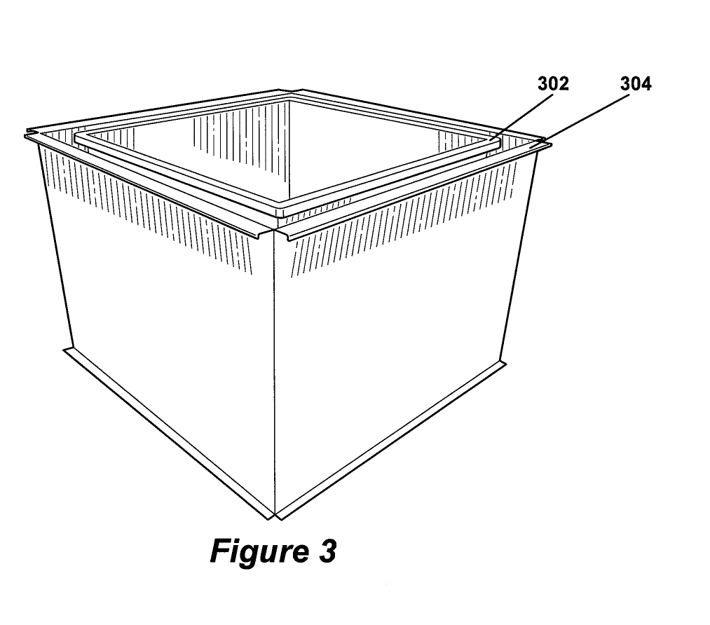

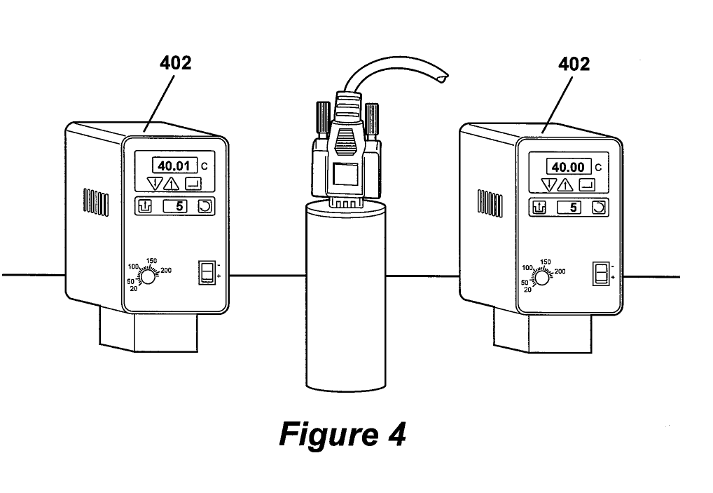

Referring to FIG. 3, depicted is a photograph of a stainless-steel water tank/bath 302 with an aluminum shell 304, as used in accordance with the teachings of this disclosure. The assembled tube/pipe test fixture shown in FIG. 1 may be immersed in a tank/bath of this kind (see FIG. 5), which may have a total fluid capacity of, for example but not limited to, approximately 180 gallons. The air gap between the stainless steel tank/bath 302 and the aluminum shell 304 is filled with an insulating material when the tank/bath is in testing service. This type of equipment has been used previously to perform experiments that require stable, high-precision temperature control from 20 to 50° C., with thermal control-cycle oscillations of <0.05° C. over weeks of continuous operation. This tight temperature control is achieved using (i) a large thermal mass of water in the water bath, (ii) two immersion heater/circulators (402 in FIG. 4), and (iii) two small submersible pumps-all serving to reach and maintain experimental temperature, and to ensure rapid circulation of the bath water.

Referring to FIG. 4, depicted is a photograph of two immersion heater/circulators 402, as used in accordance with the teachings of this disclosure (see above in the description relating to FIG. 3).

Referring to FIG. 5, depicted is a schematic diagram of a tube/pipe testing system that contains the tube/pipe test fixture illustrated in FIG. 1. According to the teachings of this disclosure, this tube/pipe testing system can be used to test the hydrogen-gas compatibilities, hydrogen-gas embrittlement susceptibilities, hydrogen-gas containment performances, and/or the hydrogen-gas pressure-cycling durabilities, of tubes and pipes. High-purity hydrogen gas, or a hydrogen-bearing gas mixture, at pressures as high as approximately 2000 psi, is loaded into, and extracted from, the interior of the tube/pipe 102 (see FIG. 1). The mass of hydrogen gas that diffuses through the wall of the tube/pipe 102 (see FIG. 2) is captured and quantitatively measured using a calibrated “leak volume” 502 connected to a high-precision, hydrogen-service, 0-20 psi pressure transducer 504. The temperature of the bath water is measured at multiple positions, as well as adjacent to the sealed tube/pipe being tested, using, for example but not limited to, high-precision thermistors. Collectively, the pieces of equipment shown in FIG. 5, and discussed herein, allow the response/performance of a tube/pipe 102 (see FIGS. 1 and 2) to be evaluated as functions of internal gas pressure, temperature, time, and gas-pressure cycling. As noted previously, the gas loaded into the interior of the tube/pipe 102 (see FIGS. 1 and 2) may be high-purity hydrogen, or a mixed gas containing hydrogen (e.g., hydrogen gas mixed with methane/natural gas and/or biomethane).

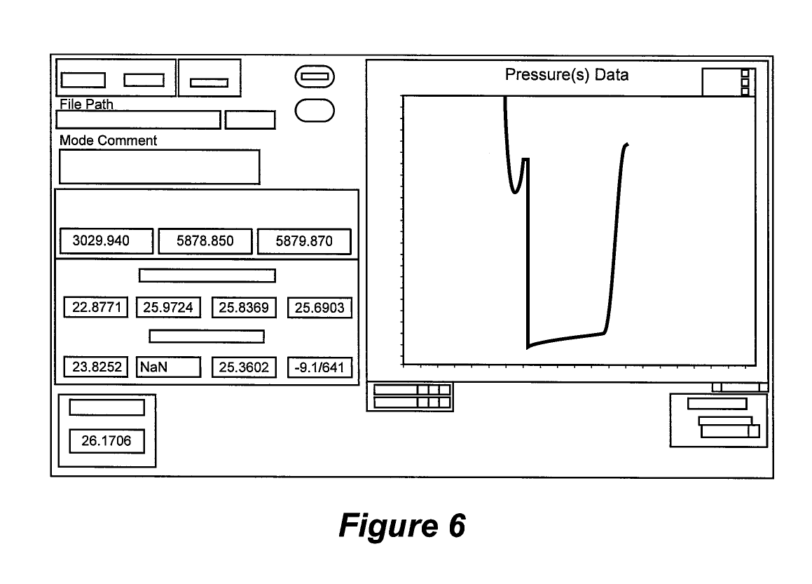

Referring to FIG. 6, depicted is a photograph of a pressure-temperature-time data recorder with a screen display that may be used in accordance with the teachings of this disclosure. Signals generated by the pressure transducers and thermistors in the tube/pipe testing system shown in FIG. 5 may be measured, linearized, and recorded using a data acquisition system assembled from components that include: a desktop personal computer; and e.g., National Instruments signal conditioning modules; and e.g., custom code developed using National Instruments LabView™ software.

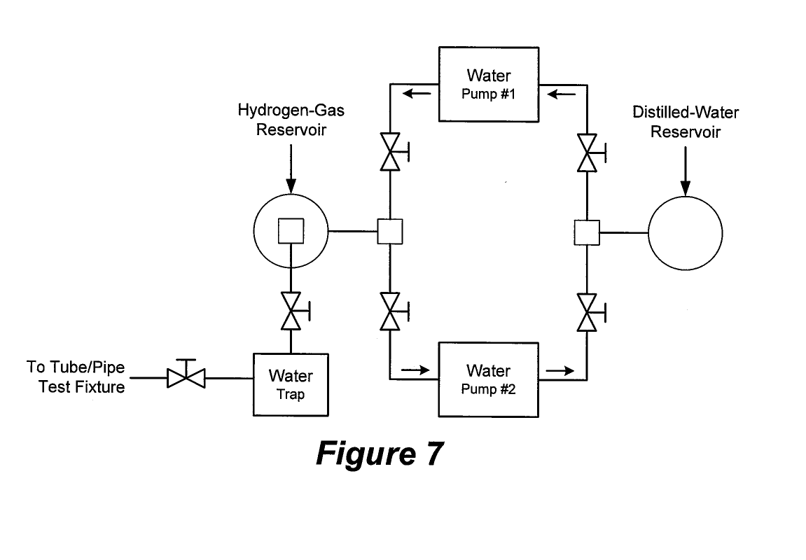

Referring to FIG. 7, depicted is a schematic diagram of an apparatus that may be used to cycle the internal gas pressures of tubes and pipes as they are being tested, according to the teachings of this disclosure. The tubes and pipes may be comprised of: single-layer, double-layer, or multi-layer metal walls; single-layer, double-layer, or multi-layer polymer walls; and double-layer or multi-layer polymer/metal walls. This gas pressure-cycling apparatus is designed to be used in conjunction with the equipment shown in FIG. 5. Generally, the gas pressure-cycling functionality achieved with the apparatus shown in FIG. 7 will involve slow variation of gas pressure between prescribed limits (e.g., 500-2000 psi) over periods of time that could be as long as several weeks. The principal pieces of equipment employed in this type of testing may be, for example: a tube/pipe test fixture (see FIG. 1); a tube/pipe 102 (see FIGS. 1 and 2); a Cu, Al or stainless-steel “filler rod”; a hydrogen-gas reservoir (FIG. 7); a small (1-3 gallon) distilled-water reservoir (FIG. 7); and 1-2 small water pumps connected to the distilled-water reservoir (FIG. 7). The filler rod, placed inside the short length (“specimen”) of tube/pipe 102 (see FIGS. 1 and 2), reduces the mass of—and therefore, the stored energy in—the compressed hydrogen gas 106 (FIGS. 1 and 2) that is loaded into the test specimen. The water pump(s) (FIG. 7) transfer(s) distilled water to and from the interior of the hydrogen-gas reservoir. Only one water pump is needed if it is reversible; otherwise, two pumps are required—one to deliver water to the hydrogen-gas reservoir, the other to extract water from that reservoir. In the descriptions below, it is assumed that two water pumps are used to achieve the required functionality.

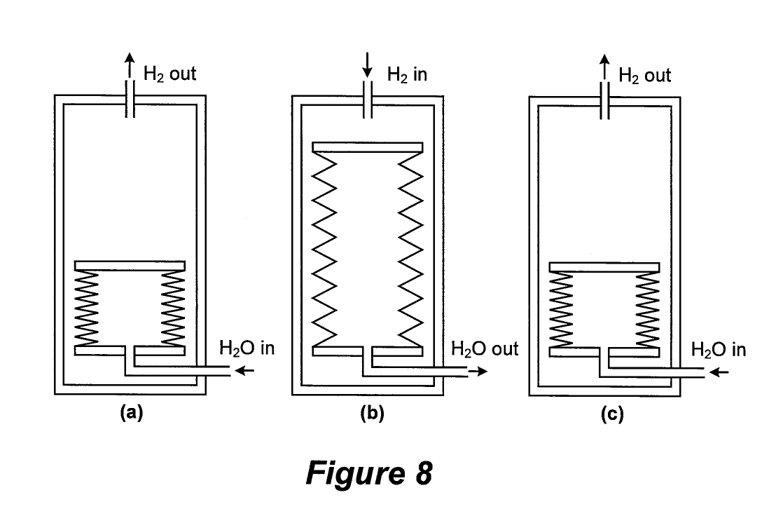

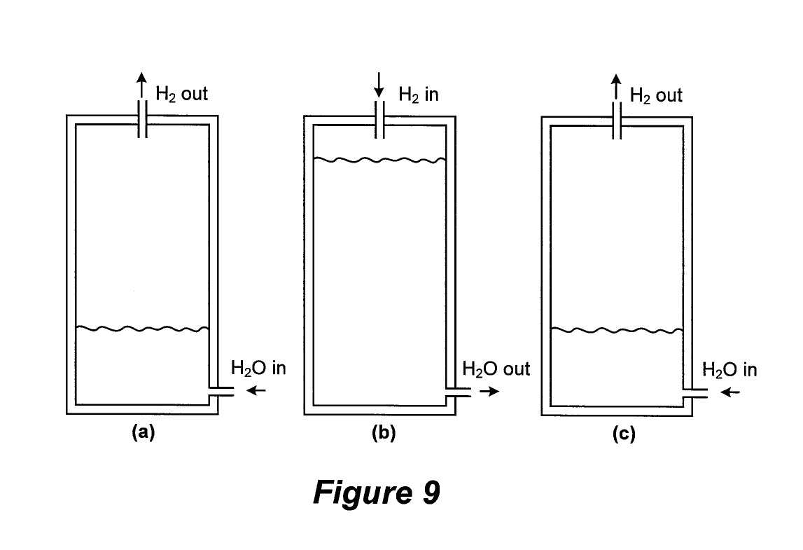

In detail, oscillating variation of gas pressure inside a tube/pipe (102 in FIGS. 1 and 2) may be achieved in one of the two following ways.
Method 1 In this method, the two small water pumps (FIG. 7) are connected to a stainless-steel bellows inside the hydrogen-gas reservoir (FIG. 7)—see FIG. 8. Water pump #1 (FIG. 7) transfers distilled water from the distilled-water reservoir to the interior of the bellows, causing it to expand, which raises gas pressure inside the hydrogen-gas reservoir and the tube/pipe 102 (see FIGS. 1 and 2). Water pump #2 (FIG. 7) transfers distilled water from the interior of the bellows to the distilled-water reservoir, causing it to contract, which lowers gas pressure inside the hydrogen-gas reservoir and the tube/pipe 102 (see FIGS. 1 and 2). Computer control of water-pumping rates furnishes the desired gas pressure-cycling in the interior of the tube/pipe 102.
Method 2 This method is similar to Method 1, the principal difference being the absence of a bellows in the interior of the hydrogen-gas reservoir (FIG. 7)—see FIG. 9. A bellows is unnecessary in Method 2 because distilled water, acting as an “inert piston,” is pumped directly into, and directly out of, the hydrogen-gas reservoir (FIG. 7), which raises and lowers gas pressure inside the tube/pipe 102 (see FIGS. 1 and 2) in a manner very similar to the way a bellows causes such changes in that pressure. Because it is in direct contact with compressed high-purity hydrogen or mixed hydrogen-bearing gas, the distilled water in the hydrogen-gas reservoir (FIG. 7) will take some of the gas into solution; thus, the distilled water is not truly “inert” in this instance. However, the amount of gas that dissolves in the distilled water will be very small. Finally, it is also true that distilled water in the hydrogen-gas reservoir (FIG. 7) will dissolve in the high-purity hydrogen, or mixed hydrogen-bearing gas; however, the amount of distilled water that dissolves will always be tiny, and easily removed from the gas by a water trap (see FIG. 7). Removal of water from the gas is desirable in many instances because, otherwise, the gas that flows into and out of the interior of the tube/pipe 102 (see FIGS. 1 and 2) will be water-bearing, which could affect measured rates of hydrogen diffusion through the wall of the tube/pipe 102.

Therefore, for example, the hydrogen-gas compatibilities, hydrogen-gas embrittlement susceptibilities, hydrogen-gas containment performances, and/or the hydrogen-gas pressure-cycling durabilities, of short lengths of 1-4 inch O.D. tubes and pipes can be tested in one or more specially designed experimental facilities (tube/pipe testing systems), each possibly including many or all of the following pieces of equipment: (i) a tube/pipe test fixture (FIGS. 1, 2 and 5); (ii) a constant-temperature water bath (FIGS. 3 and 5); (iii) two immersion heater/circulators (FIG. 4); (iv) a high-pressure cylinder of pure hydrogen gas, or a hydrogen-bearing gas mixture; (v) a high-pressure gas regulator to control hydrogen test pressure; (vi) high-precision, hydrogen-service pressure transducers to measure (a) internal tube/pipe gas pressure (FIGS. 1, 2 and 5), and (b) the pressure of hydrogen in a calibrated “leak volume” (FIG. 5); (vii) high-precision thermistor probes to measure the temperature of the water bath, and the gas inside the tube/pipe test fixture (FIGS. 1, 2 and 5); (viii) a high-pressure gas sampling cylinder (“leak volume”) (FIG. 5) to measure the mass of hydrogen gas diffusing out of the tube/pipe being tested; (ix) high-pressure capillary tubing, fittings, and valves; (x) a vacuum pump and thermocouple vacuum gauge to evacuate the tube/pipe being tested; (xi) a custom data-acquisition system consisting of a desktop computer, e.g., National Instruments signal conditioning modules, and e.g., computer code developed using LabView™ test and measurement software (FIG. 6; and (xii) various pieces of interconnected equipment (a distilled-water reservoir, two water pumps, tees and valves, a hydrogen-gas reservoir, and a water trap), used in conjunction with the apparatus listed in (i)-(xi) above, that, together, systematically raise and lower the internal gas pressure of a tube or pipe (FIGS. 1, 2 and 5).

Referring to FIG. 8, depicted is a hydrogen-gas reservoir with an internal bellows, into which distilled water is injected, and from which distilled water is extracted, according to the teachings of this disclosure (see Method 1 in the description hereinabove relating to FIG. 7).

Referring to FIG. 9, depicted is a hydrogen-gas reservoir with no internal bellows, into which distilled water is injected, and from which distilled water is extracted, according to the teachings of this disclosure (see Method 2 in the description hereinabove relating to FIG. 7).

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. An apparatus for testing hydrogen flux through barrier materials, comprising:
a source of compressed hydrogen gas;
a barrier material specimen test fixture, wherein the barrier material specimen test fixture is adapted for coupling hydrogen gas to a barrier material specimen under test, wherein the barrier material specimen forms an enclosed cavity that is pressurized from the source of compressed hydrogen gas;
at least one first pressure measurement device coupled to the barrier material specimen test fixture, wherein the at least one pressure measurement device measures the hydrogen gas pressure in the enclosed cavity of the barrier material specimen;
a temperature-controlled fluid in which the barrier material specimen test fixture and the barrier material specimen are immersed therein;
at least one temperature measurement device, wherein the at least one temperature measurement device measures the temperature of the temperature-controlled fluid;
a volume-calibrated hydrogen-gas reservoir for collecting and temporarily storing hydrogen gas that permeates through at least one wall of the enclosed cavity formed by the barrier material specimen;
at least one second pressure measurement device coupled to the volume-calibrated hydrogen-gas reservoir, wherein the at least one second pressure measurement device measures the hydrogen-gas pressure therein; and
at least one fluid pump for raising and lowering the hydrogen gas pressure inside the enclosed cavity of the barrier material specimen.

2. The apparatus according to claim 1, wherein the compressed hydrogen gas is pressure-regulated.

3. The apparatus according to claim 1, wherein the temperature-controlled fluid is held in a tank.

4. The apparatus according to claim 1, wherein the temperature-controlled fluid is air.

5. The apparatus according to claim 1, wherein the temperature-controlled fluid is water.

6. The apparatus according to claim 1, wherein the temperature-controlled fluid is mineral oil.

7. The apparatus according to claim 1, wherein the hydrogen-gas pressure in the volume-calibrated hydrogen-gas reservoir corresponds to a leak volume of hydrogen gas from the barrier material specimen under test.

8. The apparatus according to claim 1, wherein the barrier material specimen comprises at least one solid material that acts as a barrier to hydrogen flux.

9. The apparatus according to claim 8, wherein the barrier material specimen further comprises a liquid material that acts as a barrier to hydrogen flux.

10. The apparatus according to claim 1, wherein a shape of the barrier material specimen is selected from the group consisting of a cylinder, a sphere, a rectangular prism, and a cube.

11. The apparatus according to claim 1, wherein the hydrogen gas is high-purity hydrogen.

12. The apparatus according to claim 1, wherein the hydrogen gas comprises both hydrogen and methane gases.

13. The apparatus according to claim 1, wherein the barrier material specimen test fixture further comprises a porous solid material, whereby the porous solid material is used to capture and channel the flow of hydrogen gas that permeates through the barrier material specimen during testing thereof.

14. The apparatus according to claim 1, wherein the barrier material specimen test fixture further comprises a porous solid material, the porous solid material providing external structural support for the barrier material specimen.

15. The apparatus according to claim 1, wherein the source of compressed hydrogen gas is comprised of a hydrogen-gas reservoir.

16. The apparatus according to claim 1, wherein the barrier material specimen is tested for hydrogen-compatibility characteristics.

17. The apparatus according to claim 1, wherein the barrier material specimen is tested for hydrogen-embrittlement susceptibilities.

18. The apparatus according to claim 1, wherein the barrier material specimen is tested for hydrogen-containment performance.

19. The apparatus according to claim 1, wherein the barrier material specimen is tested for hydrogen pressure-cycling durability.

20. The apparatus according to claim 1, wherein the barrier material specimen comprises at least one layer.

21. The apparatus according to claim 20, wherein the at least one layer of the barrier material specimen is selected from any one or more of the group consisting of carbon steel, stainless steel, copper, and aluminum.

22. The apparatus according to claim 20, wherein the at least one layer of the barrier material specimen is selected from any one or more of the group consisting of low-temperature plastic, and a thermoplastic.

23. The apparatus according to claim 20, wherein the at least one layer of the barrier material specimen is a plurality of layers selected from any combination of at least two of the group consisting of carbon steel, stainless steel, copper, aluminum, a low-temperature plastic, a thermoplastic, and a liquid.

24. A method for testing hydrogen flux through barrier materials, said method comprising the steps of:
providing a source of compressed hydrogen gas;
providing a barrier material specimen test fixture;
providing a barrier material specimen for testing at least one hydrogen gas parameter thereof, wherein the barrier material specimen forms an enclosed cavity that is pressurized from the source of compressed hydrogen gas;
providing a temperature-controlled fluid in which the barrier material specimen test fixture and the barrier material specimen are immersed therein;
providing a volume-calibrated hydrogen-gas reservoir for collecting and temporarily storing hydrogen gas that permeates through at least one wall of the enclosed cavity formed by the barrier material specimen;
measuring the hydrogen gas pressure in the enclosed cavity of the barrier material specimen;
measuring the temperature of the temperature-controlled fluid;
measuring the hydrogen gas pressure in the volume-calibrated hydrogen-gas reservoir; and
raising and lowering the hydrogen gas pressure inside the enclosed cavity of the barrier material specimen.

25. The method according to claim 24, further comprising the step of testing hydrogen-gas compatibilities of the barrier material specimen.

26. The method according to claim 25, wherein the step of testing hydrogen-gas compatibilities comprises the step of testing for hydrogen-gas embrittlement susceptibility.

27. The method according to claim 25, wherein the step of testing hydrogen-gas compatibilities comprises the step of testing for hydrogen-gas containment performance.

28. The method according to claim 25, wherein the step of testing hydrogen-gas compatibilities comprises the step of testing for hydrogen-gas pressure-cycling durability.

29. The method according to claim 24, wherein the hydrogen gas is high-purity hydrogen.

30. The method according to claim 24, wherein the hydrogen gas is a mixture of hydrogen and methane gases.
